(19) United States
(12) Patent Application Publication
(10) Pub. No.: US 2006/0195326 A1
(43) Pub. Date: Aug. 31, 2006

(54) Database employment and transitional housing program for ex-offenders

(76) Inventors: Charles E. Okezie, Detroit, MI (US); Tanya Elizabeth Thomas, Detroit, MI (US)

Correspondence Address: Charles E. Okezie & Tanya Elizabeth Thomas, P.O. Box 971432, El Paso, TX, 79997, US

(21) Appl. No.: 10/972,918

(22) Filed: Oct. 25, 2004

Related U.S. Application Data
(60) Provisional application No. 60/517,757, filed on Nov. 5, 2003.

(51) Int. Cl. G06Q 99/00

(52) U.S. Cl. 705/1

(57) ABSTRACT

A database/software program containing information on ex-offenders, employers willing and able to hire them, and housing to the offenders for a period upon their release from prison. Employers use the information contained in the software to decide which individuals best suit their employment situation. Ex-offenders use the software to search for jobs or projects they could qualify for. Furthermore, ex-offenders use the information contained in the software concerning Transitional Housing Programs to decide which residential situation is most supportive of their temporary housing needs.

### CROSS-REFERENCE TO RELATED APPLICATIONS

This application claims the benefit of provisional patent application Ser. No. 60/517,757, filed 2003 Nov. 5 by the present inventors.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention generally relates to a system and apparatus for establishing an employment and housing program that addresses the concerns of ex-offenders. More specifically, the invention relates to a system and apparatus for allowing ex-offenders searching for employment to be matched, by prison/government officials and private agencies, with employers searching for suitable workers, using a computer implemented system which allows ex-offenders to submit relevant personal and resume information and employers to submit employment criteria and information which are used to create databases. Computer software programs are then created from those database records, allowing authorized personnel on-line access to an employment, ex-offenders, and housing information through the use of a search engine.

### BACKGROUND OF THE INVENTION—PRIOR ART

Currently, there are employment agencies that address the needs of individuals seeking new employment. The individual provides the employment agency with their resume and the agency searches for suitable employment. There are also several online employment advertising, employment agency systems available through the internet that caters to the general population. However, the specific needs of ex-offenders are not met with any form of the prior or related arts, at all, or in the way, this invention caters to their unique and frustrating situation.

This invention would require ex-offenders to provide the aforementioned, plus additional information such as, the nature of their conviction, related prison conduct record, etc., to be placed on software or database made available to potential employers. Potential employers would also submit the job descriptions, prerequisites, necessary qualifications, and other relevant information to be placed on software or database made available for ex-offenders through prison and state officials. Ex-offenders may also be required to enter job training programs prior to, and as a possible condition of early release with incentives given for compliance and as encouragement.

Furthermore, Transitional Housing, (a phrase coined with this invention) would be established where ex-offenders could reside while complying with program policy. Currently, state, federal, and city governments operate “halfway houses” and “centers” housing inmates who work and pay the government up to 25% of their weekly earnings for the duration of their stay. After a period of one to six months, when their sentences are served, they are released from the halfway house/centers. This current establishment is a hit or miss type situation where it is up to the inmate to find employment or be sent back to prison for the duration of his/her remaining sentence, which is usually only one to six months. After which time, the individual is released into the community.

Our invention could be used in conjunction with halfway houses/centers in addition to establishing temporary residences called Transitional Housing. State officials, along with other individuals who would work at these places would be trained to assist the ex-offenders with connecting with employers based on relevant criteria. This task would be made less frustrating due to the database/software programs claimed in this invention, containing employment sources whose wages, and training to the ex-offenders could be subsidized by government and private interests.

Ex-offenders can become productive members of society with the implementation of wise social programs. On Jun. 23, 2004, the Justice Kennedy Commission issued a report, which included that America's criminal justice systems rely too heavily on incarceration and that they need to consider more effective alternatives, including treatment and prisoner reentry programs.

The need for this invention is paramount now, more than ever, with a record number of people incarcerated (over 2,000,000 as of 2000)* and a record number of felons, 585,000,* being released from state and federal prisons in the year 2001. This trend is expected to continue for years to come because offenders are subject to tougher laws. Since the enactment of mandatory minimum sentencing for drug users, the federal Bureau of Prisons budget increased by more that 2,016 percent, from $220,000,000, in 1986 to about $4,437,000,000 in 2004. In August 2003, United States Supreme Court Justice Anthony Kennedy, in a speech before the annual convention of the American Bar association called for a review of “. . . the inadequacies—and the injustice—in our penal correctional systems”. By the year 2000, a record 6.3 million men and women (one out of every thirty-two adults in the U.S.A.) * were incarcerated, on parole or on probation.

State and federal legislation eliminated much training and treatment for inmates consequently; many felons lack skills and education and have difficulty finding employment. This fosters a feeling of hopelessness, increases bitterness, anger, and depression. Which in turn increases the rate of recidivism, thereby further burdening society financially, (higher taxes for instance) and otherwise (domestic violence, child abuse, and other victims for example). According to the Justice Department, the time spent in prison does not affect recidivism rates.

Many employers would be willing to take certain risks with ex-offenders if they could pay lower wages/salaries reduce training costs and qualify for tax incentives. If an industry wage is $10 per hour, and the employer pays $6.50 per hour with the remaining $3.50 paid by the state for a determined period of time, it becomes a worthwhile risk for many employers. For the government, $3.50 or so an hour for a limited time, would reduce the rate of recidivism, increase the tax base, decrease welfare expenses, and save the $28,000 a year it would cost tax payers to imprison the individual who recommits crimes. Socially conscience corporations and businesses could also take interest and help in subsidizing wages, hiring practices, training and etc.

Furthermore, many ex-offenders have serious health issues such as AID's, HIV, hepatitis C, tuberculosis, and STD's. Many are drug addicts or users who did not receive treatment in prison. By using this invention, society would benefit by the development of a more socially responsible ex-offender who would otherwise be a tax burden. To the degree that this invention is implemented it would lessen government welfare program and tax burdens by helping the ex-offender become a more productive member of society through a gainful employment and temporary housing situations.

### OBJECTS OF THE INVENTION

The principal object of the present invention is to assist ex-offenders in obtaining gainful employment prior to, or upon release, and helping employers discover working resources in ex-offenders by creating databases of potential employers and potential ex-offender employees complete with all relevant information concerning both.

A further object of this invention is to assist ex-offenders by easing their transition back into the community by providing temporary housing (heretofore referred to as Transitional Housing) and social support system. Unemployed ex-offenders have many social consequences (financial and otherwise) on our society that would be lessened through use of this invention.

### SUMMARY OF THE INVENTION

These objectives can be accomplished by the creation of computerized databases containing information on employers willing to employ ex-offenders, potential ex-offender employees, employment opportunities and information, ex-offender resumes, ex-offender personal and situational information relevant to employment, etc. in addition, information on Transitional Housing. Government programs offer few incentives for employers to hire ex-offenders that could make the risk factor less prohibitive. Current programs are ineffective due to their inefficiency in management in main part due to organizational structure and methods used in implementing their programs services. Many employers are unaware of such programs and in addition have no efficient, practical means of making informed decisions in selecting the program most beneficial to their businesses. To be familiar with each available program would be very time consuming without reasonable assurances of discovering a beneficial service.

Furthermore, no method exists that creates a pool of ex-offender applicants to be matched with Transitional Housing and a pool of employers and their employment opportunities, where an appropriate ex-offender may be hired for a particular job position based on information included in their application/resume and screened by government officials.

In addition, many ex-offenders are fully employable, but have no access or means to searching and finding employers who would hire ex-offenders. Presently as much as 90% of prisoners work for private businesses, prison industries (such as Unicor) or for the prison compound. While incarcerated these prisoners take the opportunity to gain experience, educate themselves and become telemarketers, painters, landscapers, chefs, preachers, auto mechanics, nutritionists, personal trainers, building trade and construction, lawyers, legal assistants, coaches, teachers, counselors, welders, dry cleaners just to name a few. A certain percentage of prisoners volunteer for vocational training, acquires trades, earn college degrees, and receive educational certificates. Statistics show the rate of recidivism is much lower among those who take part in such productive, self-improvement activities, than those who do not participate. With the implementation of this invention, there would be a substantial increase in prisoners volunteering to engage in such improvement and learning activities. That would increase their employment options, help them in regaining proper control of their lives and would make them able to positively contribute to society.

With this invention, potential employers could “shop” for a particular type of ex-offender from a database, whose felony record would not be a hindering factor to his/her job performance. The necessary amount of the ex-offenders criminal record would be made available to potential employers along with all the work related skills the individual possesses. On the other hand, the ex-offender could “shop” a particular type of employer and employment by searching the information contained in an employment database. The employer would include the necessary qualifications, requirements, skills, salary, and other related information. Authorized employers, prison/government officials, and private agencies acting on the ex-offenders behalf would use the software program to access the databases. Instead of the frustrating feeling of having several doors of opportunity closed to ex-offenders after diligent and persistence efforts, the ex-offender can, in a time saving manner obtain gainful employment through the use this invention. Also included in the databases are Transitional Housing options that ex-offenders may qualify to be placed in upon release, for a determined period.

Presently, there is no comprehensive program, such as is embodied in this invention that is available in the convenience and efficiency of computer software, that employers can use to take advantage of many other government programs that they are not aware of, that provide financial and other benefits to work with ex-offenders.

Figure A: Ex-offender application and information

Figure B: Ex-offender/prisoner

Figure C: Employment and employer information

Figure D: Employer

Figure E: Transitional Housing information

Figure F: Transitional Housing

Figure G: Multiple computer databases

Figure H: Government program information

Figure I: Ex-offender/employment opportunity matching computer software program

Figure J: Ex-offender/Transitional Housing matching computer software program

Figure K: Ex-offender

Figure L: Data processing personnel

Figure M: Software programmers

Figure N: Prison/government officials

Figure O: Private agencies

Figure P: Staff employers at Transitional Housing

Figure Q: Lobby personnel

Figure R: Ex-offender program website

### DETAILED DESCRIPTION OF DRAWINGS FIGURES A-R

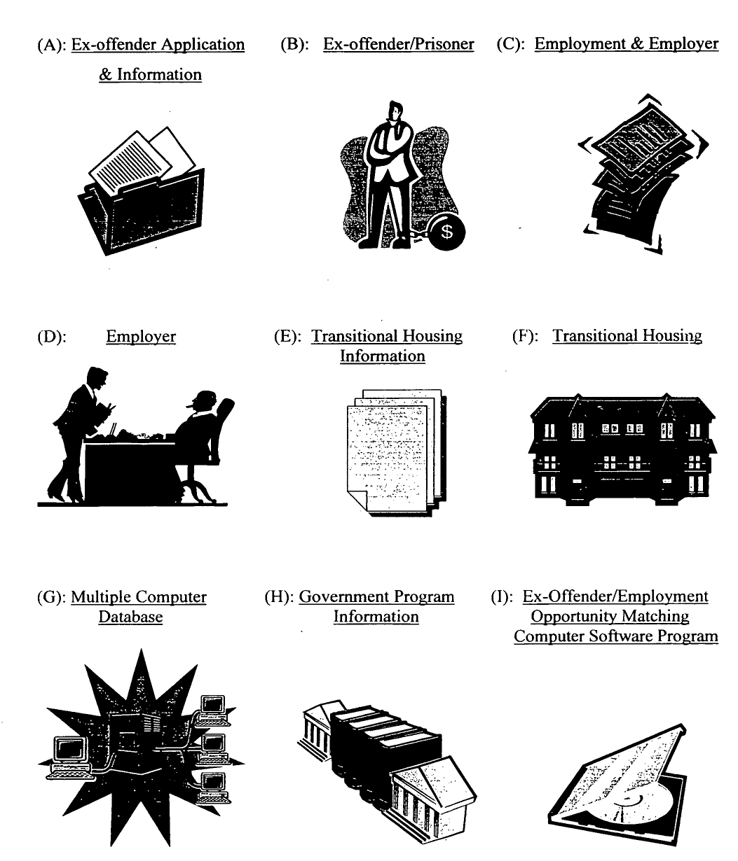

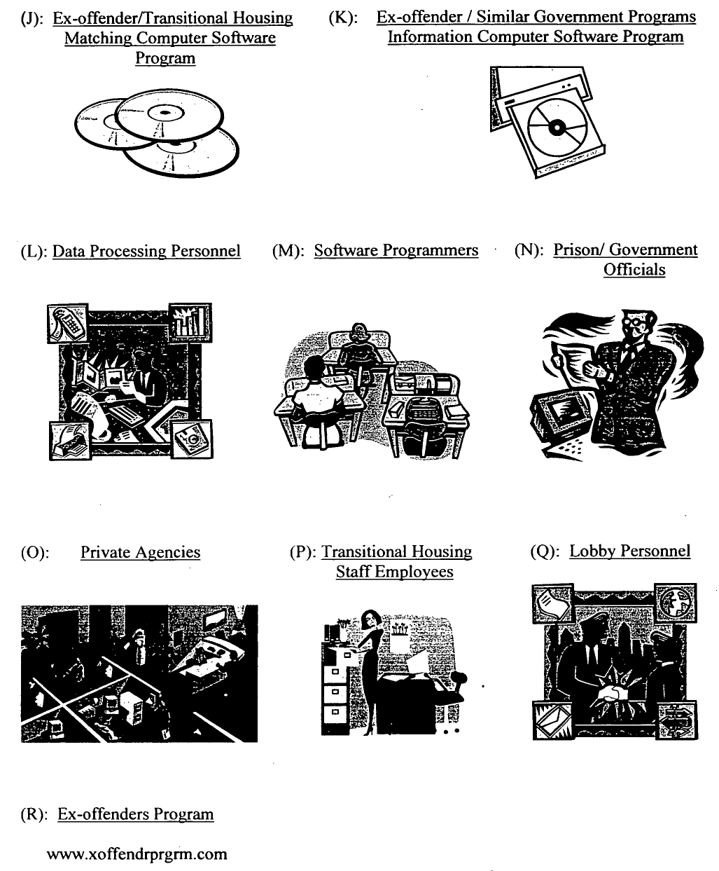

Referring now to FIG. 1, which is an overall drawing of a preferred embodiment of the invention. It shows a method of creating employment resources by ex-offenders and temporary housing (called Transitional Housing) for ex-offenders upon release, comprising of main functional components A through R.

(A): refers to the ex-offender application and information, which would be used by potential employers in selecting a suitable ex-offender employee matching the employment situation. The information would contain, but not be limited to the ex-offenders prior work experience, specific skills, education, record of conviction, prison conduct record, work ethics, etc.

(B): refers to the ex-offender who could already be released, and the prisoner who after serving the sentence will be an ex-offender.

(C): refers to employer and employment information, which would be used by ex-offenders, through their representatives, in selecting a job situation that matches their qualifications. The information would contain, but not be limited to, available positions, salary range, job requirements, duties, location, etc.

(D): refers to an employer who is willing to work with ex-offenders.

(E): refers to Transitional Housing information concerning availability, location, rules, and regulation.

(G): refers to a multiple computer database information management system that will contain databases for ex-offenders applications and information, employer applications and employment opportunity information, Transitional Housing information and similar government program information.

(H): refers to similar government program information, which are government programs that support ex-offenders or those employers who work with them.

(I): refers to an ex-offender/employment opportunity matching computer software program.

(J): refers to an ex-offender Transitional Housing matching computer software program.

(K): refers to an ex-offender/similar government programs information computer software program. The software would also contain exhaustive yet comprehensive listings of other government and private programs relating to the employers needs and benefits, criteria for qualification and financial incentives necessary for the employer to determine cost effectiveness to be considered against risk factors.

(L): refers to database processing personnel who process the information mentioned in FIG. 1A, FIG. 1C, FIG. 1E, FIG. 1H, received from the individuals mentioned in FIG. 1N, and FIG. 1D.

(M): refers to software programmers who use the information mentioned in FIG. 1L and FIG. 1G to create the software programs mentioned in FIG. 1I, FIG. 1J, and FIG. 1K.

(N): refers to prison/government officials who represent ex-offender interests and supply data entry personnel with the information mentioned in FIG. 1A, FIG. 1C, FIG. 1E, and FIG. 1H. Working with ex-offenders/inmates and employers to obtain the beneficial working relations.

(O): refers to private agencies, individuals who work on behalf of both employers and ex-offenders to secure matches in suitable employment relations.

(P): refers to staff, individuals employed at the Transitional Houses of Figure F., who assist ex-offenders in obtaining and maintaining gainful employment whilst they are housed there and enforce compliance to the programs policy and house rules.

(Q): refers to individuals who lobby government and businesses to establish and support ex-offender programs.

(R): refers to an ex-offender program website, (example) www.xoffendrprgra.com

Ex-offenders, while still incarcerated, in a halfway house/center, on parole, probation or off probation, would supply the information referred to in FIG. 1A to the individuals mentioned in FIG. 1N, FIG. 1O, and FIG. 1P. Potential employers of ex-offenders would also provide the information referred to in FIG. 1C to the individuals mentioned in FIG. 1N, FIG. 1O, and FIG. 1P. The data processing personnel of FIG. 1L would process this information into a multiple database of FIG. 1G. The database of FIG. 1G would be used by the software programmers of FIG. 1M to create the software and websites mentioned in FIG. 1H, FIG. 1I, FIG. 1J, FIG. 1K, and FIG. 1R, that ex-offenders or their representatives and employers or their representatives could access to find employment matches and contracts executed. Ex-offenders could also use the software in FIG. 1J to find placement in a suitable Transitional Housing program.

### DETAILED DESCRIPTION OF THE PREFERRED EMBODIMENTS

The above objects of this invention are substantially achieved by establishing a system whereby inmates and ex-offenders are required or requested of, to participate in a program. As mentioned in this invention where as part of their participation they are to submit applications (1A) which include information such as work skills, education, trade skills, health limitations, work experience, life goals, desired employment opportunity, etc. This information as it would be explained to them would be used in order to try to secure suitable employment for them upon release. Along with work skills, education, work experience, and other qualifications, prison conduct, behavioral issues, work ethics will be evaluated when considering suitable employment opportunities in the offenders desired job field.

Prison officials (1N) would work with inmates through encouraging them to enroll in vocational and apprenticeship programs, trades and educational courses that would be beneficial to them in helping secure employment in their desired field. Program participation does not have to be mandatory, yet incentives could be given (such as good time credit, sentence reductions, Transitional Housing Placement, (1F) Half Way House etc.) for those who choose to.

Once the ex-offender registers for participation in the program, his/her application information (1A) is reviewed and supplemented (1A) by official prison and sentencing records and updated as is necessary. This information would be passed on to data processing personnel (1L) who would place it in a computer database system(1G) as an ex-offender work resource pool, stored in electronically readable memory. A second database (within the same multiple database information exchange management system) (1G) will store information concerning employment opportunities such as salary range, job qualifications, work skills necessary, duties, and other job requirements, submitted by the employers to database personnel (1L) who store it in electronically readable memory. A third database within the same multiple database information (1G) exchange management system will store in an electronically readable memory, information concerning available Transitional Housing (1E) for ex-offenders. A fourth database within the same multiple database (1G) information exchange management system will store in an electronically readable memory, information concerning numerous other government programs (1K) for ex-offenders that provide benefits for employers who work with them. Employers would have efficient access to crosscheck other programs that could be used in conjunction with the program in this invention, or separately for theirs and ex-offenders' benefit.

This invention includes a computer program (1I, 1J, & 1K) set up as a multiple database information exchange system. The invention contains a process control unit to manage the flow of information through the system, a communication port to permit access to the system via communications with other computers connected to the network, and a database manager for establishing, changing and maintaining records of the first, second, third, and fourth databases.

The invention includes a software program, (1I, 1J, & 1K) recorded on a computer readable medium, for controlling a computer of prison/government officials, (1N0 private agencies, (1O) who act as agents and brokers on behalf of both ex-offenders (1B) and their potential employers, (1D) to generate listings of available employment positions (1C).

Transitional Housing information, (1E) ex-offender application information, and other related government program information, (1H) to assist in discovering suitable matches for employer and ex-offenders. The software programs (1I, 1J, & 1K) also able to be adapted to be operated by an employers, private agencies, (1O) and prison/government officials (1N) computers to generate a computer readable file. Which will include information concerning available employment positions (1C) and ex-offender resources qualified for those positions, available Transition Housing, (1E) and other related government programs, and can be accessed from a remote site through the internet.

Due to privacy concerns, these multi database (1G) records will include a degree of security, password system that will specify who may have access to which records; source terminal identification number may be used to verify authority for access to records, for the purposes of posting, revising, deleting, and maintaining the records of information. When an authorized user chooses to access a database, (1G) he may have an option of creating a new employment record in the job base, accessing a present employment record, pulling up ex-offender applications, (1A) updating, revising, submitting ex-offender information, (1A) updating Transitional Housing information (1E) or inputting, searching or deleting other similar government programs (1H).

The preferred embodiment of this invention uses a prison/government program, where ex-offenders (1B) as job seekers, submit applications (1A) to prison/government officials (1N) and register in the program. The applications are reviewed, organized, screened through a resume screening software program or manually, and processed by prison/government officials or private agencies (1O) with authorization. Employers (1D) apply to participate in the program and are screened through a resume screening software program or manually, and processed by the government officials. Their employment information (1C), mentioned earlier in this invention, is accepted and submitted along with the ex-offenders' application and information, (1A) and Transitional Housing information, (1E) and other similar or related government program information (1H) to data processors (1L) who process the information into a multi-database (1G) information exchange management system.

Prison/government officials (1N), and private agencies(1O) acting on the interests of the ex-offender (1B), can access the data through the use of software programming (1I, 1J, & 1K) which contains an interactive search engine to handle inquiries to the ex-offender application and information data and employment opportunity and information data, Transitional Housing data, and related programs data. In the same manner, government officials (1N) and private agencies (1C), acting on the interests of the employers, and authorized employers, can access the same data, through use of software programming (1I, 1J, & 1K) containing an interactive search engine to handle inquiries to the same databases. All parties monitor the multiple databases for matches for suitable employment situations, Transitional Housing availability, and other useful government programs that would supplement objects of this invention.

A software program (1I, 1J, & 1K) is developed to expedite the matching process, which would be used to match ex-offenders application and information (1A) to employment criteria and information (1C), and vise versa. And to match ex-offender application and information (1A) to available and suitable Transitional Housing, (1F) and to match employer business needs to any government program (1H) similar to that in this invention. The system also contains an employment opportunity and information/ex-offender application and information/Transitional Housing information/government programs (1I, 1J, & 1K) management module to manage the revision, deletion, creating, maintenance of records in all four databases, (1G). These management modules, along with the interactive search engine may also be used through commercially accessible database management systems. Other conventional query and search features may also be used to examine the databases.

In the event of a match discovered by any party, discussions are held via e-mail, phone, or in person to establish contract terms.

Government officials (1N) as well as private businesses (1O) will operate the Transitional Housing (1F). Ex-offenders (1B) who choose to reside there under the ex-offender employment program embodied in this invention will conform to established house rules. Transitional Housing (1F) will be available based on successful compliance to program policy, following the spirit of the program policy, need, attainment of employment, meeting of program financial obligations conformance to set house rules, amongst other rules and regulations. The staff (1P) at the Transitional Housing (1F0 will include resident advisors, counselors, case managers who will assist the ex-offenders residing there in ways supporting the mission and objectives of the program. The staff (1P) will be trained to utilize the computer software (1I, 1J, & 1K) to assist the ex-offenders in discovering matches with employers (1D) job training, educational courses, trade courses would also be made available to ex-offenders.

1.) A method of
(A) providing ex-offenders and employers willing to hire ex-offenders with access to each other's information for the employment consideration comprising of submitting their information to prison/government and private agencies for processing into a multiple computer database.
(B) providing employers, willing to employ ex-offenders with access to an ex-offender database in which they can select individuals to employ and provides ex-offenders access to an employment opportunity for ex-offenders database in which they can shop for jobs.

2. (canceled)

3.) Software program matching system that:
(A) Matches employers willing to hire ex-offenders and their employment criteria with ex-offenders who meet the employment criteria.
(B) Matches ex-offenders who qualify, with available Transitional Housing.
(C) Lists all similar government programs and their information and matches them with employers and ex-offenders needs.
The system comprising of search engines for:
(A) Ex-offender and employer/employment criteria matches.
(B) Transitional Housing, ex-offender qualification matches.
(C) Ex-offender/employer needs and goals based matches with other similar government programs.

4.) A method of:
(A) Matching ex-offenders seeking employment, with employers seeking suitable ex-offenders for employment.
(B) Matching ex-offenders with available Transitional Housing.
(C) Matching employers and ex-offenders based on their expressed needs, with similar government programs which support those needs, using a manual or computer system.
The method comprising, defining, and inputting such things as employment criteria, job information, ex-offender information, employer information, ex-offenders' goals, employers' needs, etc.

5.) A multiple database computer system controlled by a computer programming configured as a multiple database information exchange management system, set up for network operations, comprising of:
(A): A first database of ex-offender applications and information suitable for employment applications stored in computer readable memory.
(B): A second database of employer and employment information, and employment opportunities stored in computer readable memory.
(C): A third database of Transitional Housing Available for ex-offenders information stored in computer readable memory.
(D): A fourth database containing information on similar ex-offender government programs.
(E): A communication port suitable for receiving and transmitting data and instructions from remote computers.
(F): A manager for the database, responsible for creating, maintaining, revising, and deleting the records contained in the first database, second database, third database and fourth database.
(G): An interactive database query engine connected to said computer readable memory.
(H): A process controller connected to said manager of database, said interactive database query engine and said communication port.

6.) A method according to claim #5 comprising a system of accounting connected to said process controller. Due to the accounting system employers could be billed for accessing certain information in the databases. Various other systems could be used to charge employers for access.

7.) A computer system according to claim #5, further comprising means for relating the information of said first database, said second database, said third database, and said fourth database with each other.

8.) The Employment and Housing Program will consist of:
(A) The data processing personnel and software programmers referred to in FIG. 1L and FIG. 1M.
(B) The employer and employment information, ex-offender, ex-offend information. Transitional Housing information, similar government program information referred to in FIG. 1A, FIG. 1B, FIG. 1C, FIG. 1D, FIG. 1E, FIG. 1F, and FIG. 1H.
(C) The prison/government officials, private agencies, lobbies, Transitional Housing staff referred to in FIG. 1N, FIG. 1O, FIG. 1P, and FIG. 1Q.

9. (canceled)

10. (canceled)

11. (canceled)

12.) The Transitional Housing structures referred to in FIG. 1F.
